(19) United States
(12) Patent Application Publication
(10) Pub. No.: US 2021/0092305 A1
(43) Pub. Date: Mar. 25, 2021

(54) DESIGNATION DEVICE AND NON-TRANSITORY RECORDING MEDIUM

(71) Applicant: SHARP KABUSHIKI KAISHA, Sakai City, Osaka (JP)

(72) Inventors: TAICHI MIYAKE, Sakai City, Osaka (JP); MAKOTO OHTSU, Sakai City, Osaka (JP); TAKUTO ICHIKAWA, Sakai City, Osaka (JP)

(21) Appl. No.: 16/630,717

(22) PCT Filed: May 16, 2018
(86) PCT No.: PCT/JP2018/018970

§ 371 Date: Jan. 13, 2020

(30) Foreign Application Priority Data
Jul. 13, 2017 (JP) 2017-137354

(51) Int. Cl. H04N 5/247; H04N 5/232; H04W 4/024

(52) U.S. Cl. CPC H04N 5/247; H04W 4/024; H04N 5/232

(57) ABSTRACT

A designation device designates an object to be photographed by a mobile photographing apparatus that moves in a target section to photograph the object. The designation device includes a display processing unit configured to cause a display to display a map of the target section, and a designation receiver configured to receive a designation of a location corresponding to the object and appearing on the map. The display processing unit superimposes photographing-condition information onto the map on the basis of information about the mobile photographing apparatus to cause the display to display the photographing-condition information. The photographing-condition information indicates a location in which the mobile photographing apparatus is capable of photographing in the target section.

### TECHNICAL FIELD

The present invention relates to a designation device and a designation program.

### BACKGROUND ART

Techniques have been developed for making a self-propelled photographing apparatus that performs photographing in inspection, check, or maintenance instead of a human.

Non-Patent Document 1 discloses a technique in which a human moves the self-propelled photographing apparatus to a photographing spot by controlling the apparatus remotely while looking at a streaming video image received from a photographing device included in the self-propelled photographing apparatus. This technique, which limits the field of view of the received video image, unfortunately makes it difficult to know the current position of the self-propelled photographing apparatus. It is hence hard to guide the self-propelled photographing apparatus to a destination.

To address this problem, Patent Document 1 discloses a technique of setting a destination on a two- or three-dimensional map, followed by moving the self-propelled photographing apparatus to the destination to photograph the surroundings of the destination.

### PRIOR ART DOCUMENTS

### Patent Document

Patent Document 1: Japanese Patent Application Laid-Open No. 2016-203276, published on Dec. 8, 2016

### Non-Patent Document

Non-Patent Document 1: “Development and Improvement of Working and Exploring Robot in Nuclear Power Plant”, Journal of the Robotics Society of Japan, Vol. 32, No. 2, pp. 92-97, 2014

### SUMMARY OF INVENTION

### Problem to be Solved by Invention

In the technique described in Patent Document 1, upon receiving an operator's instruction, the self-propelled photographing apparatus moves to a photographing spot and performs photographing, followed by determining whether the photographed place is a photographing-prohibited region. For this determination, this technique requires the self-propelled photographing apparatus to take time for moving, time for determining whether normal photographing is possible, and time for transmitting the determination result to an operator's terminal. Even in a site other than a photographing-prohibited region, the technique consumes the aforementioned time before the operator recognizes a location in which the self-propelled photographing apparatus can perform photographing in a target section. The technique hence lowers working efficiency considerably.

To address this problem, the inventors, based on their unique idea, have studied that a designation device provides photographing-condition information indicating a location in which the mobile photographing apparatus can perform photographing. This designation device designates an object to be photographed by the mobile photographing apparatus that moves in a target section to photograph the object. In other words, a main object in one aspect of the present invention lies in that the designation device, which designates an object to be photographed by the mobile photographing apparatus, provides photographing-condition information indicating a location in which the mobile photographing apparatus can perform photographing.

### Means to Solve Problem

A designation device according to one aspect of the present invention designates an object to be photographed by a mobile photographing apparatus that moves in a target section to photograph the object. The designation device includes the following components: a display processing unit that causes a display to display a map of the target section; and a designation receiver that receives a designation of a location corresponding to the object and appearing on the map. The display processing unit superimposes photographing-condition information onto the map on the basis of information about the mobile photographing apparatus to cause the display to display the photographing-condition information. The photographing-condition information indicates a location in which the mobile photographing apparatus is capable of photographing in the target section.

### Effect of Invention

According to the aspect of the present invention, the designation device, which designates an object to be photographed by the mobile photographing apparatus, provides photographing-condition information indicating a location in which the mobile photographing apparatus can perform photographing.

### BRIEF DESCRIPTION OF DRAWINGS

FIG. 1 is a schematic diagram showing a remote-instruction system according to a first embodiment of the present invention.

FIG. 2 is a block diagram showing an example of the configuration of a designation device according to the first embodiment of the present invention.

FIG. 3 is a block diagram showing the functional configuration of a photographing-condition calculator according to the first embodiment of the present invention.

FIG. 4 is a diagram showing the ground surface on a three-dimensional map according to the first embodiment of the present invention.

FIG. 5 is a schematic diagram showing a photographing region of an object to be photographed, with reference to the photographing apparatus according to the first embodiment of the present invention.

FIG. 6 is a diagram showing a photographing region notified when a self-propelled photographing apparatus according to the first embodiment of the present invention performs photographing in any location.

FIG. 7 is a flowchart showing a process in the designation device according to the first embodiment of the present invention.

FIG. 8 is a diagram showing a region in which a photographing device according to a second embodiment of the present invention can perform photographing while being located right in front of an object to be photographed, and showing a region in which the photographing apparatus cannot perform photographing while being located right in front of an object to be photographed.

FIG. 9 is a diagram showing the tilt of an object surface with respect to a photographing device according to a third embodiment of the present invention.

### DESCRIPTION OF EMBODIMENTS

### First Embodiment

The following details a first embodiment of the present invention.

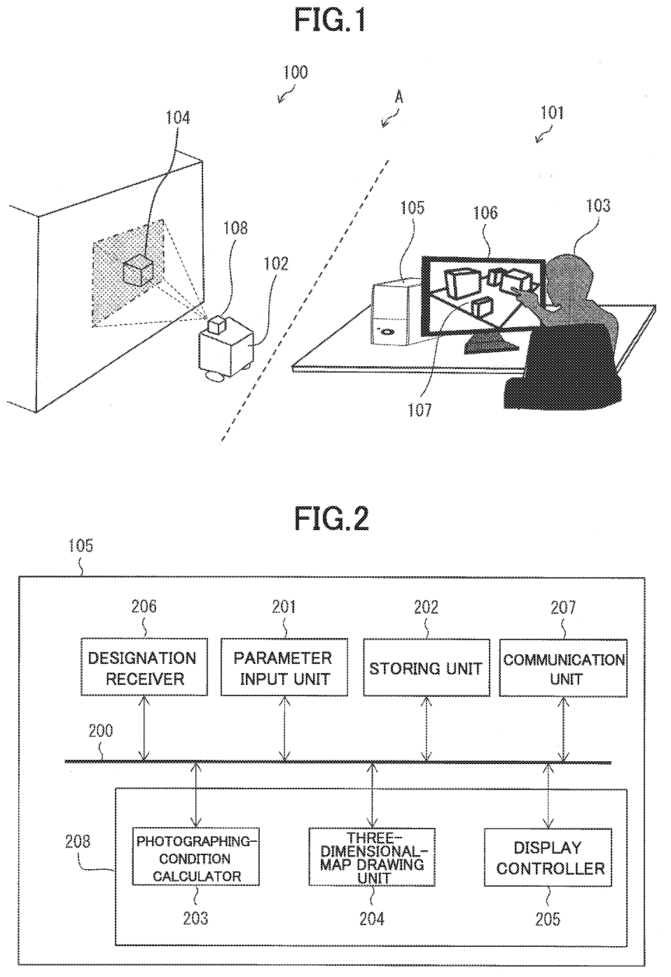

The present embodiment will be described with reference to FIGS. 1 to 7. FIG. 1 is a schematic diagram showing a remote-instruction system A according to the present embodiment.

As shown in FIG. 1, the remote-instruction system A extends to a photographing site (i.e., target section) 100 and an instruction room 101. In the remote-instruction system A, an operator 103 in the instruction room 101 enters an instruction to photograph an object 104 into a self-propelled photographing apparatus (i.e., mobile photographing apparatus) 102 located in the photographing site 100.

The operator 103 can give an instruction about the position of the object 104 (hereinafter referred to as a photographing spot) to the self-propelled photographing apparatus 102 using a designation device 105 and a display device (i.e., display) 106. The operator 103 enters the photographing spot on a three-dimensional map (i.e., stereoscopic map) 107 displayed on the display device 106.

The designation device 105 designates an object to be photographed by the self-propelled photographing apparatus 102. The self-propelled photographing apparatus 102 that has received the object designation moves autonomously to photograph the object.

FIG. 1 shows, by way of example only, that the designation device 105 and display device 106 are independent of each other. These devices may be integrated like a tablet terminal for instance.

In the example of FIG. 1, the remote-instruction system A specifically operates in the following manner. First, the operator 103 uses a touch panel or mouse to enter a photographing spot onto the three-dimensional map 107 displayed on the display device 106. The three-dimensional map 107 includes a group of objects composed of three-dimensional computer graphics (CGs) depicting the photographing site 100. Each object is provided with three-dimensional-position information.

Upon the operator 103 entering the photographing spot corresponding to the object 104 onto the three-dimensional map 107, the designation device 105 transmits information indicating the received photographing spot of the object 104 to the self-propelled photographing apparatus 102 located in the photographing site 100. Upon receiving the information indicating the photographing spot of the object 104 from the designation device 105, the self-propelled photographing apparatus 102 moves in the photographing site 100 on the basis of the photographing spot to photograph the object 104.

The self-propelled photographing apparatus 102 and designation device 105 are connected to each other via a public communication network (e.g., the Internet) and through wireless communication. Such wireless communication can be implemented through, for instance, WiFi (registered trademark) connection under an international standard (i.e., IEEE 802.11) specified by the WiFi (registered trademark) Alliance, an American industry organization. Referring to a communication network, not only a public communication network, such as the Internet, but also a local area network (LAN) used in a company and others can be used for instance. In one embodiment, a combination of such a public communication network and LAN may be used as a communication network.

The self-propelled photographing apparatus 102, although including a photographing device (i.e., photographing unit) 108 mounted on the top of the self-propelled photographing apparatus 102, as shown in FIG. 1, may be configured in any other manner. For instance, the self-propelled photographing apparatus 102 may include an arm-shaped manipulator that has a distal end where the photographing device 108 is mounted, and the self-propelled photographing apparatus 102, when photographing the object 104, may change the position of the photographing device 108 by controlling the position of the self-propelled photographing apparatus 102 and controlling the manipulator. Further, the photographing device 108 may be contained in the casing of the self-propelled photographing apparatus 102.

(Configuration of Designation Device 105)

FIG. 2 is a block diagram showing an example of the configuration of the designation device 105 according to the present embodiment. The designation device 105 includes a data bus 200, a parameter input unit (i.e., information receiver) 201, a storing unit 202, a photographing-condition calculator 203, a three-dimensional-map drawing unit 204, a display controller 205, a designation receiver 206, and a communication unit (i.e., transmitter) 207. The photographing-condition calculator (i.e., display processing unit) 203, three-dimensional-map drawing unit (i.e., display processing unit) 204, and display controller (i.e., display processing unit) 205 constitute a display processing unit 208.

The data bus 200 is used for data exchange between these units.

The parameter input unit 201 acquires a drive control parameter and a photographing control parameter from an input operation performed by the operator 103. The drive control parameter and photographing control parameter will be detailed later on. The parameter input unit 201 includes an input-output port, such as a universal serial bus (USB), as a means for external input and output. The input-output port is connected to a keyboard, mouse, and other things, via which the operator 103 can enter an instruction. The parameter input unit 201 functions also as an interface to and from an external storage.

The storing unit 202 stores the drive control parameter and photographing control parameter, received by the parameter input unit 201, and stores the three-dimensional map 107, various pieces of data calculated by the photographing-condition calculator 203, and other things. The storing unit 202 is composed of a storage, such as a random access memory (RAM) or a hard disk.

The photographing-condition calculator 203 calculates information about the photographing condition of the self-propelled photographing apparatus 102 on the basis of information about the self-propelled photographing apparatus 102 (i.e., the drive control parameter and photographing control parameter) and outputs the calculated photographing-condition information to the three-dimensional-map drawing unit 204.

The photographing-condition information indicates a photographing spot at which the self-propelled photographing apparatus 102 can perform photographing in the photographing site 100. In one embodiment, the photographing-condition information may indicate a photographing spot at which the self-propelled photographing apparatus 102 can perform photographing in the photographing site 100 in a particular manner. Alternatively, the photographing-condition information may indicate a photographing spot at which the self-propelled photographing apparatus 102 can perform photographing in the photographing site 100 in any manner. Examples of the particular manner, which will be described later on, may include a manner in which the self-propelled photographing apparatus 102 performs photographing while being located right in front of an object to be photographed, and a manner in which the self-propelled photographing apparatus 102 photographs an entire subject included in an object to be photographed. The photographing-condition information may further indicate a photographable angle at a photographing spot at which the self-propelled photographing apparatus 102 can perform photographing in the photographing site 100.

The photographing-condition calculator 203 calculates the photographing-condition information on the basis of the drive control parameter (i.e., movement capability) of the self-propelled photographing apparatus 102 and the photographing control parameter (i.e., photographing capability) of the photographing device 108. The photographing-condition calculator 203 is composed of a field programmable gate array (FPGA), an application specific integrated circuit (ASIC), and other things. A specific example of the photographing condition and a method of calculating the photographing condition will be described later on.

The three-dimensional-map drawing unit 204 and display controller 205 superimpose the photographing-condition information onto the three-dimensional map 107 to cause the display device 106 to display the superimposed photographing-condition information.

To be specific, the three-dimensional-map drawing unit 204 adjusts a depiction on the three-dimensional map 107 in accordance with the photographing-condition information acquired from the photographing-condition calculator 203. The three-dimensional-map drawing unit 204 is composed of an FPGA, an ASIC, a graphics processing unit (GPU), and other things.

The display controller 205 outputs the depiction adjusted by the three-dimensional-map drawing unit 204 to the display device 106.

The display device 106 is composed of a liquid crystal display (LCD) or an organic electro-luminescence display (OELD), and displays the depiction result sent from the three-dimensional-map drawing unit 204, a user interface (UI) for controlling the device, and other things. The display device 106 may also serve as a touch panel, which is a terminal operable by touching its display surface.

(Method of Acquiring Three-Dimensional Map)

In the present embodiment, the three-dimensional map 107, which is used in order for the operator 103 to input his/her instruction to the self-propelled photographing apparatus 102, can be acquired through a well-known method described below.

A known method of creating the three-dimensional map 107 is liking together a group of three-dimensional points obtained with a device that can measure a distance through stereo measurement using the triangulation principle and obtain three-dimensional coordinates directly, such as a device in a time of flight (TOF) scheme that measures a distance on the basis of how long it takes for infrared light to reflect on a subject. The three-dimensional map may be obtained using any method in which a map depicting three-dimensional information in the photographing site 100, including coordinates indicating object placement and wall placement.

(Photographing-Condition Calculator 203)

As earlier described, a photographing condition means the way how a photograph is seen, and is an index indicating whether the object 104 appears in the photograph correctly. An example of a criterion indicating a photographing condition, which affects the way how a photograph is seen, is parameters indicating, for instance, whether photographing is possible based on physical limitations on the self-propelled photographing apparatus 102, whether the photographing device 108 is located right in front of the object 104, how much the object 104 tilts in the photograph of the object 104, and whether the object 104 falls within an image to be photographed.

Among these photographing conditions, the present embodiment handles whether the photographing device 108 can perform photographing. The following describes the functional configuration, in block form, of the photographing-condition calculator 203, a specific calculation method, and the process performed in the designation device 105.

(Functional Configuration of Photographing-Condition Calculator 203 in Block Form)

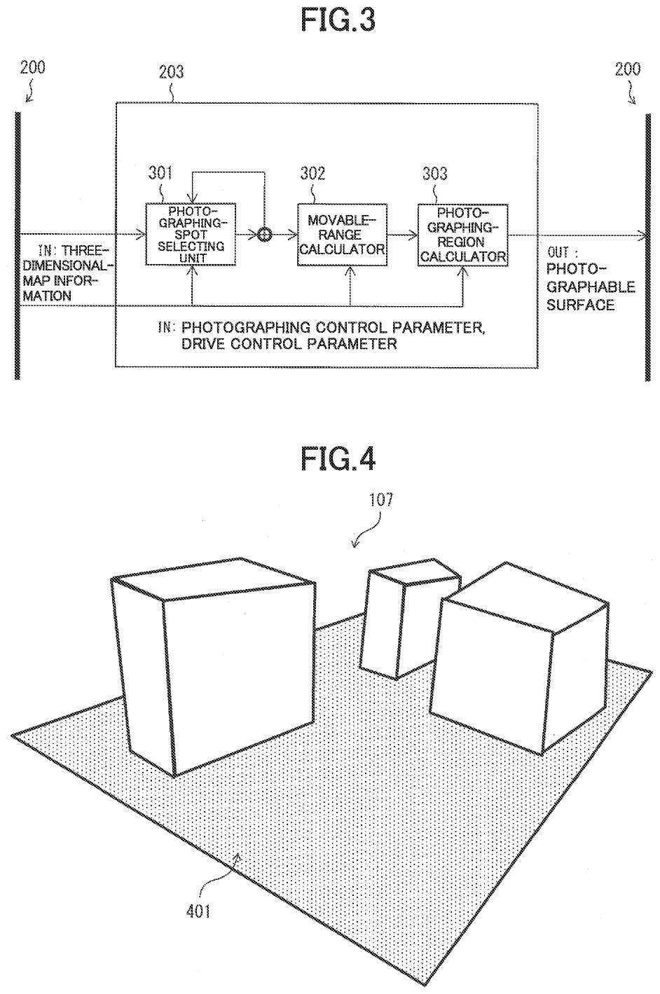

With reference to FIGS. 3 and 4, the functional configuration, in block form, of the photographing-condition calculator 203 will be described in an aspect of calculating whether the photographing device 108 can perform photographing. FIG. 3 is a block diagram showing the functional configuration of the photographing-condition calculator 203 according to the present embodiment. FIG. 4 is a diagram showing a ground surface 401 on the three-dimensional map 107 according to the present embodiment.

As shown in FIG. 3, the photographing-condition calculator 203 includes a photographing-spot selecting unit (i.e., designation controller) 301, a movable-range calculator 302, and a photographing-region calculator 303.

The photographing-spot selecting unit 301 reads the three-dimensional map 107 in the target section, from the storing unit 202 and causes the display device 106 to display the three-dimensional map 107. Based on physical limitations, such as the width of the self-propelled photographing apparatus 102, the photographing-spot selecting unit 301 selects a place for the self-propelled photographing apparatus 102 to photograph an object (hereinafter referred to as a photographing place) from among freely-selected coordinates on the ground surface 401 shown in FIG. 4. The photographing-spot selecting unit 301 outputs the photographing place corresponding to a received object to be photographed or outputs the coordinates of the selected photographing place to the movable-range calculator 302.

The movable-range calculator 302 calculates the movable range of the photographing device 108 of the self-propelled photographing apparatus 102 at the coordinates of the photographing place selected by the photographing-spot selecting unit 301. The movable-range calculator 302 calculates the movable range on the basis of what has been input as a drive control parameter. How to calculate the movable range will be described later on. The movable-range calculator 302 calculates such movable ranges as groups of three-dimensional coordinate points at which the photographing device 108 can exist, and removes an overlap between the movable ranges, followed by outputting the movable range to the storing unit 202 and photographing-region calculator 303.

The photographing-region calculator 303 calculates coordinate points (i.e., the position of an object to be photographed) falling within a region to be photographed by the photographing device 108 and appearing on the three-dimensional map 107. The photographing-region calculator 303 outputs the calculation result to the three-dimensional-map drawing unit 204.

(Drive Control Parameter and Photographing Control Parameter)

The drive control parameter indicates parameters expressing an appearance feature of the self-propelled photographing apparatus 102 and the movable ranges of the devices included in the self-propelled photographing apparatus 102 (e.g., the photographing device 108 and manipulator). An example of the drive control parameter is a parameter indicating the shape of the self-propelled photographing apparatus 102, such as the width, height, and depth of the casing of the self-propelled photographing apparatus 102. Other examples of the drive control parameter include the placement location of the photographing device 108 and the range of the pan angle and tilt angle of the mounted photographing device 108 (i.e., an external parameter expressing the position and photographing direction of the photographing device 108). For a manipulator mounted on the self-propelled photographing apparatus 102, examples of the drive control parameter include the movable range of the manipulator, the position of the manipulator joints, and the length between the manipulator joints.

The photographing control parameter indicates an internal parameter that is inherent information about the photographing device 108 (e.g., information about a characteristic of an optical sensor and about a lens distortion), and a parameter, such as the field angle of the lens. The internal parameter of the photographing device 108 may be calculated through typical camera calibration included in a general-purpose library, such as open source computer vision library (OpenCV). Alternatively, the internal parameter may be calculated through a method using a camera calibrator whose three-dimensional position is known. The photographing control parameter may undergo calibration in advance, and the calibration result may be stored in the storing unit 202.

By way of example only, casing height, casing width, casing depth, and the position and photographing direction of the photographing device 108 are used as the drive control parameter in the present embodiment that is used to calculate whether photographing is possible. By way of example only, the horizontal field angle and vertical field angle of the photographing device 108, and the focal length included in the internal parameter are used as the photographing control parameter in the present embodiment.

(How to Select Photographing Spot)

The photographing-spot selecting unit 301 selects any set of coordinates on the ground surface 401. Based on the drive control parameter acquired from the parameter input unit 201, the photographing-spot selecting unit 301 then determines whether the self-propelled photographing apparatus 102 can reach the selected coordinates. If determining that the self-propelled photographing apparatus 102 can reach the selected coordinates, the photographing-spot selecting unit 301 determines the position of the selected coordinates as a photographing place. If determining that the self-propelled photographing apparatus 102 cannot reach the selected coordinates, the photographing-spot selecting unit 301 selects another set of coordinates. The photographing-spot selecting unit 301 repeatedly selects another set of coordinates until determining that the self-propelled photographing apparatus 102 can reach the selected coordinates.

The self-propelled photographing apparatus 102 determines whether the self-propelled photographing apparatus 102 can reach the selected coordinates, by, for instance, determining whether the straight distance between the selected coordinates and the surfaces of surrounding objects exceeds the width and depth of the casing.

(Calculation of Movable Range of Photographing Device 108)

The movable-range calculator 302 calculates candidates for the possible position of the mounted photographing device 108. When the photographing device 108 is disposed at the distal end of the manipulator, the movable-range calculator 302 can determine the possible position of the photographing device 108 through the kinematics of a robot, thus outputting the movable range as a group of coordinates. The robot kinematics is a method of calculating the position of the distal end of the manipulator, from information about an angle at which each joint of the manipulator of the self-propelled photographing apparatus 102 can move and from information about the length between the joints.

For the self-propelled photographing apparatus 102 with the photographing device 108 secured in a casing having no manipulator, the photographing device 108 is not movable; thus the movable-range calculator 302 outputs where the photographing device 108 is placed in the self-propelled photographing apparatus 102, without calculating the movable range.

(How to Calculate Photographing Region)

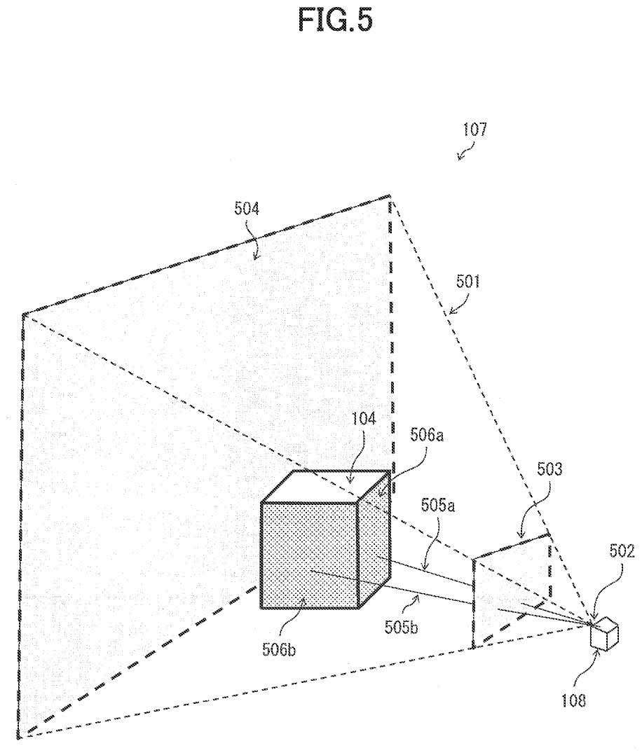

With reference to FIG. 5, the following describes how the photographing-region calculator 303 calculates a region in which the photographing device 108 can perform photographing on the three-dimensional map 107. FIG. 5 is a schematic diagram showing the photographing region of the object 104. The photographing region is included in a view frustum (i.e., range in which the photographing device 108 can perform photographing) with reference to the photographing device 108 according to the present embodiment.

First, the photographing-region calculator 303 selects, as the position of the photographing device 108, one of a group of coordinates acquired from the movable-range calculator 302 and being the movable range of the photographing device 108. The photographing-region calculator 303 next determines the position and size of a near clipping plane 503 on the basis of the vertical field angle and horizontal field angle of the photographing device 108, the focal length, and the photographing direction. The photographing-region calculator 303 subsequently sets a far clipping plane 504 having four corners that are disposed on the respective extension lines of straight lines 501 and being equidistant from an optical-axis origin 502 of the photographing device 108, the straight lines 501 being drawn from the optical-axis origin 502 to the four corners of the near clipping plane 503. In this case, provided is a space called a view frustum defined by the near clipping plane 503 and far clipping plane 504, and by planes formed by the straight lines 501 connecting the four corners of each clipping plane.

Here, as shown in FIG. 5, the photographing-region calculator 303 draws straight lines 505a and 505b from the optical-axis origin 502 until intersecting with the respective object surfaces. The photographing-region calculator 303 then calculates, as photographing regions 506a and 506b, surfaces to which the respective intersections in this case belong and that fall within the view frustum. The photographing-region calculator 303 calculates such photographing regions until scanning the entire near clipping plane 503.

The photographing-region calculator 303 calculates photographing regions with regard to all directions in which the photographing device 108 can perform photographing. The photographing-region calculator 303 also outputs a group of coordinates constituting surfaces obtained as photographing regions, to the three-dimensional-map drawing unit 204 as photographing-condition information indicating a photographing spot at which the self-propelled photographing apparatus 102 can perform photographing in the photographing site 100.

(How to Notify Photographing Condition)

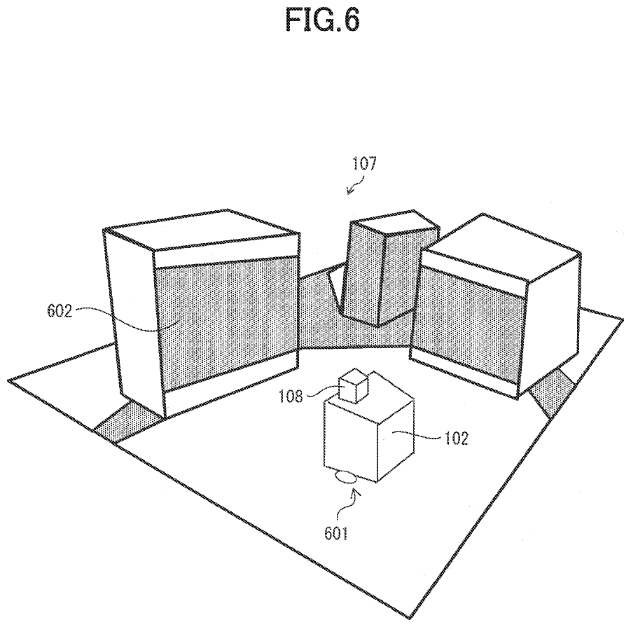

How to notify a photographing condition will be described with reference to FIG. 6. FIG. 6 is a diagram showing a photographing region (i.e., photographing-condition information) that is notified when the self-propelled photographing apparatus 102 according to the present embodiment performs photographing in any location.

Based on the information about the coordinate group of the photographing region acquired from the photographing-region calculator 303, the three-dimensional-map drawing unit 204 notifies the operator 103 of the photographing condition by adjusting a depiction of the surface of an object to which the appropriate coordinates belong.

For instance, the three-dimensional-map drawing unit 204 notifies the operator 103 of the photographing condition by drawing such that surface color, texture, and other things are different between a photographable range of the photographing device 108 and a non-photographable range of the photographing device 108. FIG. 6 shows a reference sign 602 denoting the photographable range of the self-propelled photographing apparatus 102 at a photographing spot 601.

The method of notifying the photographing condition is non-limiting. An example of the notification method is drawing only a surface in a photographable range and erasing the rest. Another example is setting a dark color in a location in which photographing is not possible unless the photographing direction is moved to the limit of the pan angle or tilt angle, and conversely, changing color to a bright color in a location in which photographing is possible without particularly moving the manipulator. A still another example is changing color to a bright color when photographable regions overlap in a plurality of locations on the ground surface 401. Still further examples include providing a sound using the pattern of an object surface or using mouseover, and transmitting a vibration using an external or internal function. That is, in the method of notifying the photographing condition, different photographing conditions need to be conveyed to an operator visually, acoustically or tactically, or through a combination of these senses.

(Process in Designation Device 105)

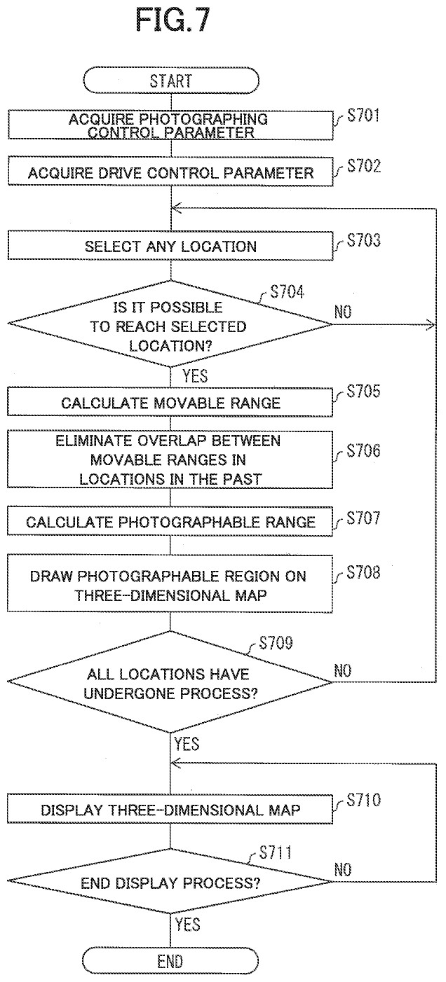

A process of notifying a photographable region that is performed by the designation device 105 will be described with reference to FIG. 7. FIG. 7 is a flowchart showing the process in the designation device 105 according to the present embodiment.

In Step S701, the parameter input unit 201 acquires a photographing control parameter that is set in the self-propelled photographing apparatus 102. The parameter input unit 201 then outputs the photographing control parameter to the photographing-condition calculator 203.

In Step S702, the parameter input unit 201 acquires a drive control parameter. The parameter input unit 201 then outputs the drive control parameter to the photographing-condition calculator 203. It is noted that the parameter input unit 201 can omit Steps S701 and S702 when the photographing control parameter, acquired in Step S701, and the drive control parameter, acquired in Step S702, are held in the storing unit 202.

In Step S703, the photographing-spot selecting unit 301 of the photographing-condition calculator 203 reads the three-dimensional map 107 from the storing unit 202, and selects any set of coordinates on the ground surface 401 as a photographing spot.

In Step S704, based on the drive control parameter, the photographing-spot selecting unit 301 determines whether the self-propelled photographing apparatus 102 can reach the photographing spot indicated by the coordinates selected in Step S703. If determining that the self-propelled photographing apparatus 102 cannot reach the photographing spot (i.e., if NO in Step S704), the photographing-spot selecting unit 301 goes back to Step S703. If determining that the self-propelled photographing apparatus 102 can reach the photographing spot (i.e., if YES in Step S704), the photographing-spot selecting unit 301 outputs the coordinate values selected in Step S703 to the movable-range calculator 302 and then proceeds to Step S705.

In Step S705, based on the drive control parameter of the self-propelled photographing apparatus 102 output in Step S702 and on the coordinate values of the photographing spot output in Step S704, the movable-range calculator 302 of the photographing-condition calculator 203 calculates a group of coordinates as the range of the photographing device 108 at the aforementioned coordinates.

In Step S706, the movable-range calculator 302 extracts an overlap between one or more movable ranges calculated in the past, with regard to the coordinate group of the photographing device 108 output in Step S705. The movable-range calculator 302 outputs the result with the overlap eliminated from the movable range of the photographing device 108, to the photographing-region calculator 303 as movable-range information.

In Step S707, the photographing-region calculator 303 calculates a region in which the photographing device 108 can perform photographing, on the basis of the photographing control parameter output in Step S701, the drive control parameter output in Step S702, and the movable-range information of the photographing device 108 output in Step S706. The photographing-region calculator 303 outputs the calculated photographable region to the three-dimensional-map drawing unit 204 as photographing-condition information indicating a photographing spot at which the self-propelled photographing apparatus 102 can perform photographing in the photographing site 100.

In Step S708, the three-dimensional-map drawing unit 204 draws the photographable region on the three-dimensional map 107 on the basis of the calculation result of the photographable region output in Step S707.

In Step S709, the designation device 105 determines whether Steps S703 to S708 have been performed with regard to all the coordinates on the ground surface 401 of the three-dimensional map 107. If these process steps have not been performed with respect to all the coordinates on the ground surface 401 (i.e., if NO in Step S709), the designation device 105 goes back to Step S703 to repeat the process step of selecting any location and the process steps of calculating and drawing a photographable region. If these process steps have been performed with regard to all the coordinates on the ground surface 401 (i.e., if YES in Step S709), the three-dimensional-map drawing unit 204 outputs, to the display controller 205, the three-dimensional map 107 with the photographable region visible. The designation device 105 then proceeds to Step S710.

In Step S710, the display controller 205 outputs the three-dimensional map 107 to the display device 106. The designation device 105 then proceeds to Step S711.

In Step S711, the designation device 105 determines whether to end the displaying of the three-dimensional map 107. If determining not to end the displaying (i.e., if NO in Step S711), the designation device 105 goes back to Step S710. If determining to end the displaying (i.e., if YES in Step S711), the designation device 105 ends the whole process.

### Effect in First Embodiment

The aforementioned configuration achieves the designation device 105 that notifies a photographing condition on the three-dimensional map 107 when an operator enters an instruction about a photographing spot into the self-propelled photographing apparatus 102 using the three-dimensional map 107.

### Second Embodiment

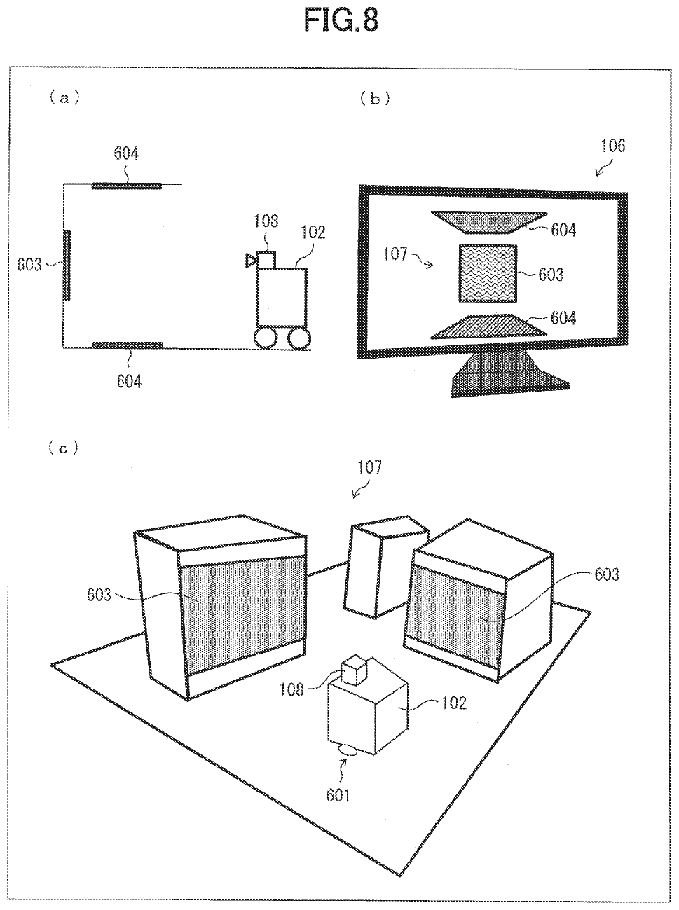

The following describes a second embodiment of the present invention with reference to FIG. 8. For the sake of convenience in description, components whose functions are the same as those described in the first embodiment are denoted by the same signs and will not be elaborated upon.

The second embodiment is different from the first embodiment in that the photographing-condition information calculated by the photographing-condition calculator 203 further indicates an object range in which the photographing device 108 can or cannot perform photographing in a target section while being located right in front of an object to be photographed. The other configuration and process are similar to those in the first embodiment.

FIG. 8 shows regions 603 and 604. The region 603 is a region in which the photographing device 108 according to the present embodiment can perform photographing while being located right in front of an object to be photographed. The region 604 is a region in which the photographing device 108 cannot perform photographing while being located right in front of an object to be photographed.

(Process in Designation Device 105)

The photographing-region calculator 303 calculates a normal vector at coordinates on the three-dimensional map 107, with regard to the surface determined to be photographable by the photographing-region calculator 303 in Step S707 in FIG. 7.

The photographing-region calculator 303 next calculates an optical-axis vector in a photographing direction of the photographing device 108 located in the movable range calculated in Step S705 in FIG. 7.

The photographing-region calculator 303 then normalizes the normal vector and optical-axis vector individually (i.e., the photographing-region calculator 303 processes each of the normal vector and optical-axis vector into a unit vector), followed by calculating the inner product of the normal vector and optical-axis vector.

Furthermore, when the photographing-region calculator 303 determines that the calculated inner product value is smaller than a negative threshold (i.e., close or equal to minus one), the normal vector and optical-axis vector face each other. In this case, the photographing-region calculator 303 identifies the surface corresponding to the normal vector as the region 603, a region where the photographing device 108 can perform photographing while being located in front of an object to be photographed. Then, as shown in FIG. 8 (c), the photographing-region calculator 303 outputs the region 603, a region where the photographing device 108 can perform photographing at the photographing spot 601 while being located right in front of an object to be photographed, to the three-dimensional-map drawing unit 204 as photographing-condition information indicating a photographing spot at which the self-propelled photographing apparatus 102 can perform photographing in the photographing site 100 while being located right in front of the object. The photographing-region calculator 303 accordingly visualizes the region 603 on the three-dimensional map 107.

It is noted that when the aforementioned inner product value is equal to or greater than the negative threshold with regard to the surface determined to be photographable, the designation device 105 may visualize the photographable surface as the region 604, a region where the photographing device 108 cannot perform photographing while being located right in front of an object to be photographed. It is also noted that upon the operator 103 giving an instruction about an object to be photographed to the self-propelled photographing apparatus 102, the designation device 105 may distinguish the region 603 from the region 604 by color to draw these regions on the three-dimensional map 107, as shown in FIG. 8 (b), thus notifying the operator 103 of the regions 603 and 604, which are respectively photographable and non-photographable with the photographing device 108 located right in front of an object to be photographed.

### Effect in Second Embodiment

The photographing device 108 can photograph even an object located obliquely forward while being located right in front of the object, depending on the directional adjustment of the photographing device 108 using the pan and tilt angles. This requires the operator 103 to recognize a photographing control parameter to select a photographable object.

The designation device according to the present embodiment notifies, in advance, the operator 103 of which photographing spot is to be selected to obtain a photograph taken by the photographing device located right in front of an object to be photographed. The designation device thus enables a photographing instruction to be input efficiently.

The designation device is useful, particularly in photographing an object that should be photographed by the photographing device located right in front of the object. For instance, the designation device is useful in photographing a crack or photographing scales and a measuring instrument together. The photographing device 108, when being movable, is very useful because it can change its position and orientation so as to be located right in front of a surface determined to be photographable.

### Third Embodiment

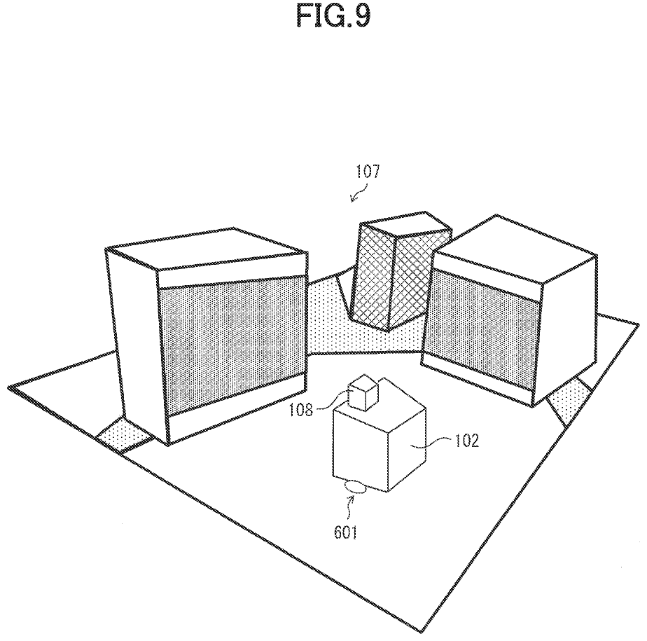

The following describes a third embodiment of the present invention with reference to FIG. 9. For the sake of convenience in description, components whose functions are the same as those described in the first and second embodiments are denoted by the same signs and will not be elaborated upon.

The third embodiment is different from the first embodiment in that the photographing-condition information calculated by the photographing-condition calculator 203 further indicates a photographable angle regarding an object that can be photographed by the photographing device 108 in a target section. The other configuration and process are similar to those in the first embodiment.

FIG. 9 is a diagram showing the tilt of an object surface with respect to the photographing device 108 according to the present embodiment. That is, FIG. 9 shows how much an object, when photographed, are tilted in a photographed image.

The self-propelled photographing apparatus 102 is not always capable of photographing while being located right in front of an object to be photographed, and often photographs a tilted object. Further, the self-propelled photographing apparatus 102 photographs an object that falls within a photographable region. The object in the photograph can be distorted greatly.

To address this problem, the present embodiment describes identifying an object that can be photographed by the photographing device 108, followed by clearly indicating, in the display device 106, how much a surface forming the object on the three-dimensional map 107 is tilted with respect to the photographing device 108 located at the photographing spot 601, as shown in FIG. 9, to notify the operator 103 of how much the object is tilted.

(Process in Designation Device 105)

The photographing-region calculator 303 calculates a normal vector at coordinates on the three-dimensional map 107 with regard to each surface determined to be photographable by the photographing-region calculator 303 in Step S707 in FIG. 7.

The photographing-region calculator 303 next calculates an optical-axis vector in a photographing direction of the photographing device 108 located in the movable range calculated in Step S705 in FIG. 7.

The photographing-region calculator 303 then calculates the angle formed between the normal vector and optical-axis vector. Let an optical-axis vector O have a component of (o₁, o₂, o₃), and let a normal vector N have a component of (n₁, n₂, n₃). Then, the aforementioned angle can be determined by Expression 1 below.

$$[ Math . 1 ]$$

$$cos θ = ( {o}_{1} {n}_{1} + {o}_{2} {n}_{2} + {o}_{3} {n}_{3} ) \text{/} ( \sqrt{{o}_{1}^{2} + {o}_{2}^{2} + {o}_{3}^{2}} \sqrt{{n}_{1}^{2} + {n}_{2}^{2} + {n}_{3}^{2}} ) , where 0 < θ < 90 ° \qquad Expression 1$$

With regard to the surfaces determined to be photographable, the photographing-region calculator 303 then includes information indicating the calculated angle into the photographing-condition information to output the photographing-condition information to the three-dimensional-map drawing unit 204. In response to the photographing-condition information, the three-dimensional-map drawing unit 204 draws the surfaces while distinguishing the surfaces by color in accordance with an angle range indicated for the photographable surfaces. The three-dimensional-map drawing unit 204 may change brightness contained in surface color information, in accordance with the angle between the normal vector and optical-axis vector, for instance. In one example, the three-dimensional-map drawing unit 204 may change the brightness to maximum when the self-propelled photographing apparatus 102 is most located right in front of an object to be photographed, and may decrease the brightness as the angle is closer to the right angle (i.e., 90 degrees).

It is noted that the designation device 105 may normalize the normal vector and optical-axis vector individually before calculating the angle between the normal vector and optical-axis vector.

### Effect in Third Embodiment

The designation device according to the present embodiment notifies how much each surface (i.e., object to be photographed) within the photographing region on the three-dimensional map 107 will be tilted when the surface is actually photographed. This configuration enables the operator 103 to select the way how the object, when photographed, will been seen other than the way how the object will been seen when photographed with the photographing device located right in front of the object. The operator 103 consequently has more options when selecting an object to be photographed.

In particular, the aforementioned configuration is useful when, for instance, the operator 103 designates an object to be photographed, within a photographing region, wants to know whether an object will be photographed correctly, or designates an object that may be photographed while being tilted to a certain degree.

### Fourth Embodiment

The following describes a fourth embodiment of the present invention. For the sake of convenience in description, components whose functions are the same as those described in the first to third embodiments are denoted by the same signs and will not be elaborated upon.

The fourth embodiment is different from the first embodiment in that the photographing-condition information calculated by the photographing-condition calculator 203 further indicates whether the photographing device 108 can photograph, in a target section, an entire subject located at a photographable spot. The other configuration and process are similar to those in the first embodiment.

In the designation of an object to be photographed, the entire object can fall beyond a photographed image depending on a photographing condition, such as the photographing device 108 being too close to the object (i.e., subject) or the object being too large. The photographing device 108 can photograph the object within the photographed image when being distant from the object. In some cases, however, the photographing device 108 cannot photograph the object within the photographed image no matter where the photographing device 108 is positioned in places, including a narrow place where the photographing device 108 is not sufficiently distant from the object, and a place with many obstacles. Accordingly, a photographing condition indicating, for instance, whether the object can be photographed within the photographed image, is clearly indicated on the three-dimensional map 107 to notify the operator 103 of the photographing condition. Examples of the photographing condition include a condition where the object cannot be photographed within the photographed image because there is something (e.g., a wall) behind, a condition where the object can be photographed within the photographed image if the photographing device 108 moves away from the object greatly, and a condition where the object can be photographed within the photographed image without any particular action being done.

(Process in Designation Device 105)

As a prerequisite, the photographing-region calculator 303 has acquired, in advance, information indicating the size of an object to be photographed and the position of the object on the three-dimensional map 107.

The photographing-region calculator 303 next calculates view frustums at respective photographing spots determined to be photographable as earlier described. As shown in FIG. 5, the far clipping plane 504 of the view frustum has a size that increases in proportion to the distance from the optical-axis origin 502 of the photographing device 108 to the far clipping plane 504.

The photographing-region calculator 303 further calculates the distance from the position of the photographing device 108 to the position of the object. When the far clipping plane in a location that is away from the optical-axis origin 502 of the photographing device 108 by this distance is smaller than the object, the photographing-region calculator 303 determines that the entire object will not be photographed within the photographed image. The photographing-region calculator 303 then outputs the determination result to the three-dimensional-map drawing unit 204 as photographing-condition information indicating a spot at which the self-propelled photographing apparatus 102 can photograph the entire subject in the photographing site 100, to visualize the determination result on the three-dimensional map 107.

### Effect in Fourth Embodiment

The designation device according to the present embodiment enables the operator 103 to receive a notification indicating whether an object will be photographed within a photographed image.

### Fifth Embodiment

The following describes a fifth embodiment of the present invention. For the sake of convenience in description, components whose functions are the same as those described in the first to fourth embodiments are denoted by the same signs and will not be elaborated upon.

The fifth embodiment describes the modifications of the first to fourth embodiments regarding the means for giving a notification to the operator 103. The other configuration and process are similar to those in the first to fourth embodiments.

In the first embodiment, the three-dimensional-map drawing unit 204 may change the color or texture on the three-dimensional map 107 on the basis of the photographing-condition information.

In the third embodiment, the three-dimensional-map drawing unit 204 may change the brightness in accordance with the surface tilt of an object to be photographed.

In the third embodiment, the three-dimensional-map drawing unit 204 may change, to a bright color, the color of the position of an object to be photographed in a photographable region, the position being photographable without moving the manipulator.

### Regarding First to Fifth Embodiments

In each of the aforementioned embodiments, the configurations and other things shown in the accompanying drawings are mere examples, and can be thus changed as appropriate, within a range in which the effects of the present invention are achieved. The others can be changed as appropriate, for implementation, without departing from the scope of the purpose of the present invention.

Although each embodiment described above has described that the components for achieving functions are members that are different from each other, members that are actually recognizable in a clearly separate manner do not necessarily have to be included. A remote-work supporting device enabling the function of each embodiment described above may include each component for enabling the function constituted by, for example, actually different parts, or may include all the components mounted on one LSI. That is, each of the components is included as the function in any mounting manner. Each of the components of the present invention can be freely selected, and the present invention includes an aspect including the selected configuration as well.

A program for achieving the function described in the aforementioned individual embodiment may be stored in a computer-readable recording medium. The stored program may then be read and executed by a computer system, thus performing the process in each component. The computer system herein includes an OS and hardware components, such as a peripheral device.

The computer system herein includes a homepage providing environment (or displaying environment) when a WWW system is used.

The computer-readable recording medium herein refers to a portable medium (e.g., a flexible disk, a magneto-optical disk, a ROM, and a CD-ROM) or a storage (e.g., a hard disk built in the computer system). The computer-readable recording medium includes a medium that dynamically retains the program for a short period of time, like a communication line that is used to transmit the program over a network (e.g., the Internet) or a communication circuit (e.g., a telephone circuit), and a medium (e.g., a volatile memory within the computer system that functions as a server or client) that retains, in that case, the program for a fixed period of time. Moreover, the aforementioned program may be configured to enable some of the aforementioned functions, and additionally may be configured to enable these functions in combination with a program already recorded in the computer system.

[Examples Enabled by Software]

The display processing unit 208 has control blocks (i.e., photographing-condition calculator 203, three-dimensional-map drawing unit 204, and display controller 205) that may be enabled by a logic circuit, which is hardware, formed by an integrated circuit (i.e., IC chip) and other things, or by software with a central processing unit (CPU).

For software with a CPU, the display processing unit 208 includes the following by way of example: a CPU that executes the commands of a program, which is software for enabling each function; a read only memory (ROM) or storage (referred to as a recording medium) that records the program and various data pieces readable by a computer (or CPU); and a random access memory (RAM) that develops the program. The computer (or CPU) reads the program from the recording medium and executes the program. This achieves the purpose of the present invention. An example of the recording medium usable herein is a non-transitory tangible medium, including a tape, disk, card, semiconductor memory, and programmable logic circuit. The program may be supplied to the computer via any transmission medium (e.g., a communication network and a broadcast wave) that can transmit the program. It is noted that one aspect of the present invention can be achieved in the form a data signal implemented by electronic transmission of the program and embedded in a carrier wave.

### SUMMARY

A designation device according to a first aspect of the present invention designates an object to be photographed by a mobile photographing apparatus that moves in a target section to photograph the object. The designation device includes the following components: a display processing unit that causes a display to display a map (i.e., the three-dimensional map 107) of the target section; and a designation receiver that receives a designation of a location corresponding to the object and appearing on the map. The display processing unit superimposes photographing-condition information onto the map on the basis of information about the mobile photographing apparatus to cause the display to display the photographing-condition information. The photographing-condition information indicates a location in which the mobile photographing apparatus can perform photographing in the target section.

Such a configuration enables the designation device to suitably provide the photographing-condition information, indicating a location in which the mobile photographing apparatus can perform photographing, on the basis of the information about the mobile photographing apparatus.

A designation device according to a second aspect of the present invention is configured such that, in the first aspect, the information about the mobile photographing apparatus indicates one or more of the shape of the mobile photographing apparatus and the movable range, external parameter, internal parameter, and field angle of a photographing unit (i.e., the photographing device 108). The photographing unit is included in the mobile photographing apparatus.

Such a configuration enables the photographing-condition information, indicating a location in which the mobile photographing apparatus can perform photographing in a target section, to be provided accurately on the basis of the information about the mobile photographing apparatus.

A designation device according to a third aspect of the present invention may further include, in the first and second aspects, an information receiver that receives an input of the information about the mobile photographing apparatus.

Such a configuration enables the designation device to easily acquire the information about the mobile photographing apparatus.

A designation device according to a fourth aspect of the present invention may be configured such that, in the first to third aspects, the map is a three-dimensional map.

Such a configuration achieves more intuitive designation of the object to be photographed.

A designation device according to a fifth aspect of the present invention may be configured such that, in the first to fourth aspects, the photographing-condition information indicates a location in which the mobile photographing apparatus can perform photographing in the target section while being located right in front of the object.

Such a configuration enables photographing-condition information to be provided that indicates a location in which the mobile photographing apparatus can perform photographing more suitably.

A designation device according to a sixth aspect of the present invention may, in the first to fifth embodiments, indicate a plurality of locations in which the mobile photographing apparatus can perform photographing in the target section, and indicate, for each indicated location, an angle at which the mobile photographing apparatus can perform photographing.

Such a configuration enables photographing-condition information to be provided that indicates a location in which the mobile photographing apparatus can perform photographing more suitably.

A designation device according to a seventh aspect of the present invention may be configured such that, in the first to sixth aspects, the photographing-condition information indicates a location in which the mobile photographing apparatus can photograph an entire subject in the target section.

Such a configuration enables photographing-condition information to be provided that indicates a location in which the mobile photographing apparatus can perform photographing more suitably.

A designation device according to an eighth aspect of the present invention may be configured such that, in the first to seventh aspects, the display processing unit changes color or texture on a three-dimensional map on the basis of the photographing-condition information.

Such a configuration, in which the color or texture on the three-dimensional map is changed, enables easy-to-understand notification of the photographing condition.

The designation device according to a ninth aspect of the present invention may, in the first to eighth aspects, further include the following components: the display (i.e., display device 106); and a transmitter (i.e., communication unit 207) that transmits the position of the object to the mobile photographing apparatus, the position of the object corresponding to the location appearing on the map received by the designation receiver.

Such a configuration enables a more suitable instruction to be given to the mobile photographing apparatus.

The designation device according to each aspect of the present invention may be implemented by a computer. In this case, the present invention encompasses a control program for the designation device that is implemented with the computer by operating the computer as each component (i.e., software element) of the designation device. The present invention also encompasses a computer-readable recording medium that records the control program.

The present invention is not limited to each of the embodiments. Various modifications can be devised within the scope of the claims. Moreover, embodiments that are obtained in combination, as appropriate, with the technical means disclosed in the respective different embodiments are also included in the technical scope of the present invention. Furthermore, combining these disclosed technical means can create a new technical feature.

### CROSS-REFERENCE TO RELATED APPLICATION

The present application claims priority to Japanese Patent Application No. 2017-137354, filed Jul. 13, 2017, the contents of which are incorporated herein by reference in their entirety.

### EXPLANATION OF REFERENCE SIGNS

102 self-propelled photographing apparatus (mobile photographing apparatus)
108 photographing device (photographing unit)
105 designation device
106 display device (display)
107 three-dimensional map
201 parameter input unit (information receiver)
203 photographing-condition calculator
204 three-dimensional-map drawing unit
205 display controller
206 designation receiver
207 communication unit (transmitter)
208 display processing unit

1. A designation device that designates an object to be photographed by a mobile photographing apparatus that moves in a target section to photograph the object, the designation device comprising:
a display processing unit configured to cause a display to display a map of the target section; and
a designation receiver configured to receive a designation of a location corresponding to the object and appearing on the map,
wherein the display processing unit superimposes photographing-condition information onto the map on the basis of information about the mobile photographing apparatus to cause the display to display the photographing-condition information, the photographing-condition information indicating a location in which the mobile photographing apparatus is capable of photographing in the target section while being located right in front of the object.

2. (canceled)

3. The designation device according to claim 1, further comprising an information receiver configured to receive an input of the information about the mobile photographing apparatus.

4. The designation device according to claim 1, wherein the map comprises a three-dimensional map.

5-7. (canceled)

8. The designation device according to claim 1, wherein the display processing unit changes a color or texture depicted on a three-dimensional map, on the basis of the photographing-condition information.

9. The designation device according to claim 1, further comprising:
the display; and
a transmitter configured to transmit a position of the object to the mobile photographing apparatus, the position corresponding to the location on the map received by the designation receiver.

10. A non-transitory recording medium containing a designation program for operating a computer as the designation device according to claim 1, the designation program being used for operating the computer as the display processing unit and designation receiver.

11. A designation device that designates an object to be photographed by a mobile photographing apparatus that moves in a target section to photograph the object, the designation device comprising:
a display processing unit configured to cause a display to display a map of the target section; and
a designation receiver configured to receive a designation of a location corresponding to the object and appearing on the map,
wherein the display processing unit superimposes photographing-condition information onto the map on the basis of information about the mobile photographing apparatus to cause the display to display the photographing-condition information, the photographing-condition information indicating a plurality of locations in which the mobile photographing apparatus is capable of photographing in the target section, and indicating, for each indicated location, an angle at which the mobile photographing apparatus is capable of photographing.

12. The designation device according to claim 11, wherein the information about the mobile photographing apparatus indicates one or more of a shape of the mobile photographing apparatus and a movable range, external parameter, internal parameter, and field angle of a photographing unit, the photographing unit being included in the mobile photographing apparatus.

13. The designation device according to claim 11, wherein the photographing-condition information indicates a location in which the mobile photographing apparatus is capable of photographing an entire subject in the target section.
